(19) United States
(12) Patent Application Publication
(10) Pub. No.: US 2009/0190962 A1
(43) Pub. Date: Jul. 30, 2009

(54) Developing Device and Image-Forming Apparatus

(75) Inventors: Takeshi AOKI, Matsumoto-shi (JP); Yoshihiro NAKASHIMA, Suwa-shi (JP); Hiroshi KATO, Okaya-shi (JP); Masaru KOBASHI, Matsumoto-shi (JP); Takatomo FUKUMOTO, Shiojiri-shi (JP)

Correspondence Address: HOGAN & HARTSON L.L.P., 1999 AVENUE OF THE STARS, SUITE 1400, LOS ANGELES, CA, 90067, US

(73) Assignee: SEIKO EPSON CORPORATION, Tokyo (JP)

(21) Appl. No.: 12/360,704

(22) Filed: Jan. 27, 2009

(30) Foreign Application Priority Data
Jan. 29, 2008 (JP) 2008-017201

(51) Int. Cl. G03G 15/08

(52) U.S. Cl. 399/260

(57) ABSTRACT

A developing device includes a housing having inner walls, a toner container disposed in the housing, a supply roller disposed in the toner container so as to oppose one of the inner walls and rotating to move a toner, and a development roller to which the toner is supplied from the supply roller. The inner wall of the housing opposing the supply roller has a recess and a protrusion that allow the toner moved by the rotation of the supply roller to flow in a specific direction so as to agitate the toner.

### BACKGROUND

1. Technical Field

The present invention relates to a developing device that develops electrostatic latent images on a latent image support with a toner supplied to a development roller by a supply roller, and to an electrophotographic image-forming apparatus including the developing device, such as a copy machine, a facsimile, or a printer.

2. Related Art

In the developing device of a general image-forming apparatus, the toner in a toner container is supplied to a development roller by a supply roller. The toner supplied by the development roller is transported to a photoreceptor while being restrained by a toner restraint member, and the toner develops electrostatic latent images on the photoreceptor.

In such a developing device, the toner in the toner container is prevented from solidifying by being circulated in plane perpendicular to the longitudinal direction of the developing device. Accordingly, the toner container is conventionally equipped with a stirring mechanism, such as an agitator or an auger rod, to forcibly agitate the toner while the toner is conveyed in the longitudinal direction of the developing device. In the technique of forcibly agitating the toner with a stirring mechanism, such as an agitator, however, a stress is placed on the toner and the toner is liable to deteriorate accordingly. In addition, the stirring mechanism increases the size of the developing device.

Accordingly, for example, Japanese Unexamined Patent Application Publication No. 2002-221852 proposes a rotary developing unit as a developing device. In this developing device, the toner container has a predetermined number of ribs slanting in the longitudinal direction of the developing device inside. By rotating a rotary, the ribs allow the toner to flow in the longitudinal direction of the developing device while agitating the toner.

Since this developing device does not use an agitator or other special stirring mechanisms to forcibly agitate the toner, the stress applied to the toner by agitation can be reduced. The developing device of the above-cited patent document does not require a stirring mechanism, and the size of the device can be reduced accordingly.

However, the developing device of the above-cited patent document requires the rotary rotating so that the ribs allow the toner to flow in the longitudinal direction while agitating the toner. Hence, the structure disclosed in the above-cited patent document is difficult to apply to developing devices other than the rotary developing type.

In addition, since a predetermined number of ribs are provided within the toner container, the internal structure of the toner container becomes intricate and the size of the toner container is increased. The presence of the ribs results in an intricate large developing device.

### SUMMARY

An advantage of some aspects of the invention is that it provides a downsized developing device including a toner container having a simple internal structure, not requiring forcible agitation, capable of being applied to development other than rotary development, and to an image-forming apparatus including the developing device.

According to an aspect of the invention, a developing device is provided which includes a housing having inner walls, a toner container disposed in the housing, a supply roller disposed in the toner container so as to oppose one of the inner walls, and a development roller to which the toner is supplied from the supply roller. The inner wall of the hosing opposing the supply roller has a recess and a protrusion that allow the toner moved by the rotation of the supply roller to flow in a specific direction so as to agitate the toner. Thus, the rotation of the supply roller moves the toner in a direction perpendicular to the longitudinal direction of the developing device, and the recess and the protrusion circulate the toner in the longitudinal direction. Consequently, the toner can be agitated effectively without forcible agitation.

Thus, the degradation of the toner can be prevented. Even if the toner is degraded, the degraded toner does not lean to one side. Thus, fog or leakage of the toner from the toner restraint member 28 can be reduced.

Preferably, the recess has a width in the specific direction and the width is increased toward the supply roller and reduced toward the opposite side to the supply roller. Preferably, the protrusion has a width in the specific direction and the width is reduced toward the supply roller 26 and increased toward the opposite side to the supply roller 26, and predetermined numbers of the recesses and the protrusions are alternately arranged in the specific direction. Consequently, as the distance between the toner and the supply roller is increased, the force applied in the longitudinal direction of the developing device from the boundaries between the recesses and the protrusions is increased. Thus, the toner can efficiently be moved in the longitudinal direction by the rotation of the supply roller.

Preferably, the recesses and the protrusions have a step height therebetween increasing toward the opposite side to the supply roller. Preferably, the boundaries between the recesses and the protrusions have slopes having a tilt angle that is smaller on a side distant from the supply roller than on a side closer to the supply roller. Consequently, the toner can more efficiently be moved in the longitudinal direction of the developing device by the rotation of the supply roller. Thus, the toner can be sufficiently agitated.

Preferably, the protrusions are arranged according to the sizes of transfer materials in such a manner that at least two of the protrusions are located at both ends of a transfer material in the lateral direction in an orientation in which the transfer material is transported. Thus, the difference in degree of degradation of the toner caused by circulating the toner particularly when a small transfer material is printed can be reduced between the printing region and the region outside the printing region.

Preferably, the recesses and the protrusions are alternately arranged at a pitch that is reduced toward the center of the arrangement and increased toward the ends of the arrangement. Consequently, the toner can be agitated finely at the center in the longitudinal direction of the developing section and roughly at the ends in the longitudinal direction.

Since the toner is moved and agitated only by the rotation of the supply roller, the above structure can be applied to various types of developing device, including a rotary developing device, a tandem developing device, and a monochrome developing device, as long as a supply roller is used.

In addition, the recesses and the protrusions are integral with the housing. Accordingly, the internal structure of the toner container can be simple and the toner container can be small. Accordingly, the developing device can be simple and small.

### BRIEF DESCRIPTION OF THE DRAWINGS

The invention will be described with reference to the accompanying drawings, wherein like numbers reference like elements.

FIG. 1 is a schematic view of an image-forming apparatus according to an embodiment of the invention.

FIG. 2A is a left side view of a developing device according to an embodiment of the invention; FIG. 2B is a front view of the developing device; and FIG. 2C is a sectional vies taken along line IIC-IIC in FIG. 2A.

FIGS. 3A and 3B are cross sectional views taken along lines IIIA-IIIA and IIIB-IIIB in FIG. 2B, respectively, and FIG. 3C is a sectional view taken along line IIIC-IIIC in FIG. 2C.

FIGS. 4A to 4C are schematic views of developing devices according to other embodiments of the invention.

### DESCRIPTION OF EXEMPLARY EMBODIMENTS

The invention will further be described with reference to exemplary embodiments and accompanying drawings.

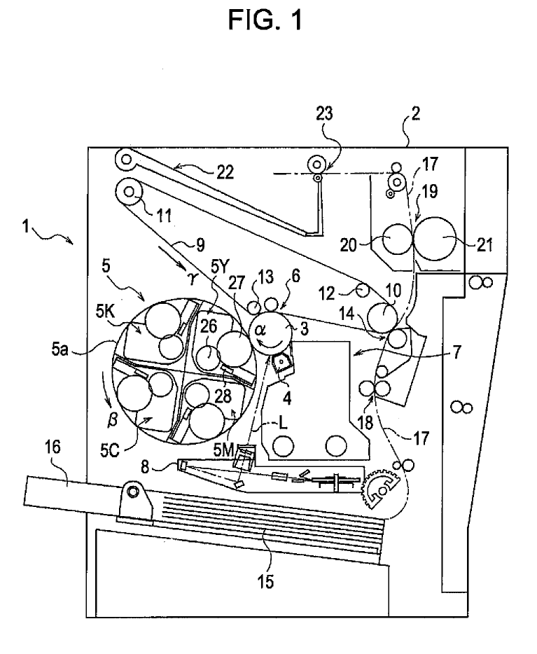

FIG. 1 is a schematic view of an image-forming apparatus according to an embodiment of the invention.

The image-forming apparatus 1 shown in FIG. 1 basically has the same structure as the known image-forming apparatus of the above-cited patent document. Part having the same structure as in the known image-forming apparatus will first be described.

The image-forming apparatus 1 includes an enclosure 2 in which a photoreceptor 3 being a latent image support is disposed for rotation in an α direction (clockwise direction in FIG. 1). An electrifying device 4 is disposed in the vicinity of the periphery of the photoreceptor 3. Also, a developing device or a rotary developing unit 5, a primary transfer device 6, and a cleaning device 7 are disposed in that order in the a direction from the electrifying device 4 around the periphery of the photoreceptor 3. The rotary developing unit 5 includes a yellow developing section 5Y, a magenta developing section 5M, a cyan developing section 5C, and a black developing section 5K. These developing sections 5Y, 5M, 5C, and 5K are removably supported to a rotary 5a capable of rotating in a β direction (counterclockwise in FIG. 1) on the central axis of the rotary. In addition, an exposure unit 8 is disposed below the rotary developing unit 5 and the cleaning device 7.

The image-forming apparatus 1 further includes an endless intermediate transfer belt 9 acting as an intermediate transfer medium. The intermediate transfer belt 9 is passed over a belt driving roller 10, a driven roller 11, and two guide rollers 12 and 13. One of the two guide rollers 12 and 13 may act as a tension roller applying a tension to the intermediate transfer belt 9. The belt driving roller 10 receives a rotation driving force from a motor (not shown). The belt driving roller 10 thus moves the intermediate transfer belt 9 in a γ direction (counterclockwise in FIG. 1) while the primary transfer device 6 is pressing the intermediate transfer belt 9 on the photoreceptor 2.

A secondary transfer device 14 is disposed on the belt driving roller side of the intermediate transfer belt 9. Also, a transfer material cassette 16 containing transfer material 15, such as transfer paper or transfer sheet, is disposed under the exposure unit 8. Furthermore, a gate roller pair 18 is disposed close to the secondary transfer device 14 in the passage 17 of the transfer material from the transfer cassette 16 to the secondary transfer device 14.

A fixing device 19 is disposed above the secondary transfer device 14. The fixing device 19 includes a heating roller 20 and a pressure roller 21 to press the transfer material on the heating roller 20. In addition, an ejected transfer material tray 22 is disposed at an upper side in the enclosure 2. A transfer material ejection roller pair 23 is disposed between the fixing device 19 and the ejected transfer material tray 22.

In the image-forming apparatus 1 having such a structure, the electrifying device 4 uniformly electrifies the photoreceptor 3, and, for example, a yellow electrostatic latent image is first formed on the photoreceptor 3 with, for example, laser light L emitted from the exposure unit 8. The yellow electrostatic latent image on the photoreceptor 3 is developed with a yellow toner of the yellow developing section 5Y aligned with the developing point by the rotation of the rotary 5a. Thus, a yellow toner image is formed on the photoreceptor 3. The yellow toner image is transferred to the intermediate transfer belt 9 by the primary transfer device 6. After transfer, the toner remaining on the photoreceptor 3 is scraped off by a cleaning blade of the cleaning device 7 and is collected.

Then, the photoreceptor 3 is electrified again by the electrifying device 4, and, for example, a magenta electrostatic latent image is formed in the same manner as above, using the exposure unit 8. The magenta electrostatic latent image is transferred with a magenta toner of the magenta developing section 5M aligned with the developing point. The magenta toner image on the photoreceptor 3 is transferred to be superposed on the yellow toner image on the intermediate transfer belt 9 by the primary transfer device 6. After transfer, the toner remaining on the photoreceptor 3 is collected by the cleaning device 7. Furthermore, cyan and black toner images are formed on the photoreceptor 3 one after the other, and transferred to be superposed on the previously transferred images on the intermediate transfer belt 9, in the same manner. Thus, a full color toner image is formed on the intermediate transfer belt 9. After transfer, the toners remaining on the photoreceptor 3 are collected by the cleaning device 7, in the same manner.

A full color toner image is transferred to a transfer material 15 transported onto the intermediate transfer belt 9 from the transfer material cassette 16 through the transfer material passage 17 by the secondary transfer device 14. In this instance, being timed to the movement of the full color toner image 15 on the intermediate transfer belt 9, the transfer material 15 is transported to the secondary transfer device 14 by the gate roller pair 18.

The toner image transferred onto the transfer material 15 is heated and pressed to be fixed by the fixing device 19. The transfer material 15 onto which an image has thus been formed is transported through the transfer material transport passage 17, and is ejected and held into the ejected transfer material tray 22 by the transfer material ejection roller pair 23.

The featured structure of the image-forming apparatus 1 of the embodiment will now be described.

The developing sections 5Y, 5M, 5C, and 5K of the image-forming apparatus 1 have the identical structure. In the following description, the letters Y, M, C, and K of the reference numerals of the developing sections will be omitted, and the developing sections are collectively described as a developing device designated by reference numeral 5, being differentiated from the rotary developing unit 5.

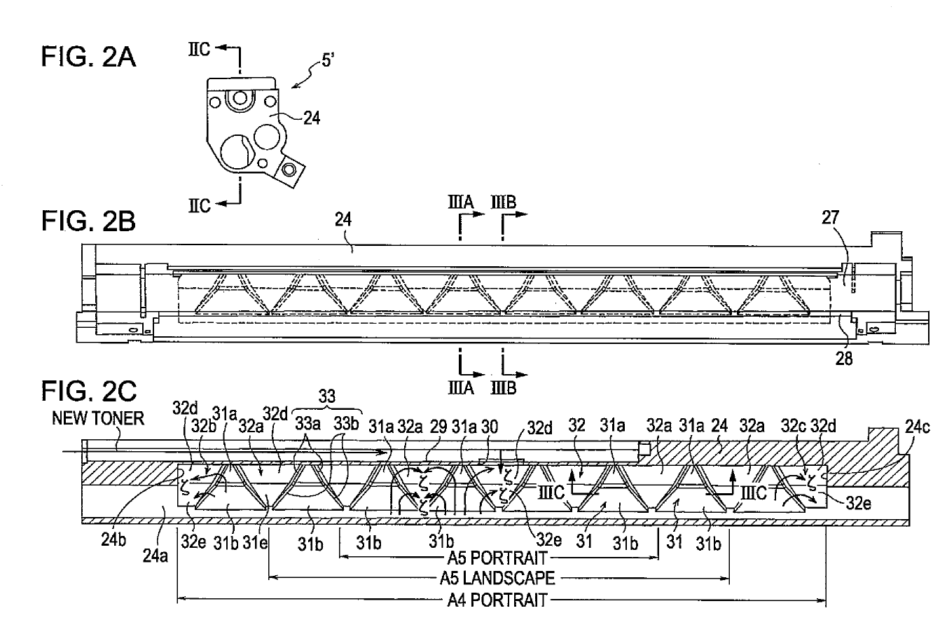

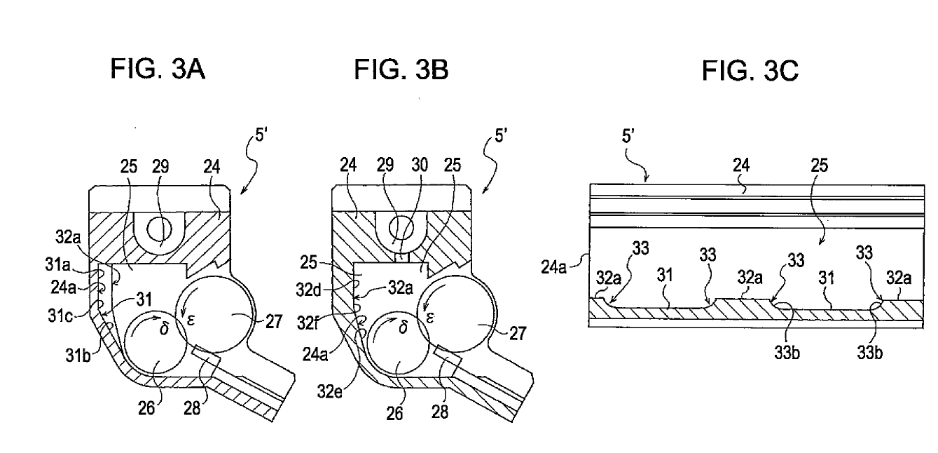

FIGS. 2A to 2C show the developing device 5′. FIG. 2A is a left side view of the developing device 5′; FIG. 2B is a front view of the developing device 5′ (viewed from the photoreceptor side); and FIG. 2C is a longitudinal sectional view taken along line IIC-IIC in FIG. 2A. In FIG. 2C, the supply roller 26 is omitted. FIGS. 3A and 3B are cross sectional views taken along lines IIIA-IIIA and IIIB-IIIB in FIG. 2B, respectively, and FIG. 3C is a sectional view taken along line IIIC-IIIC in FIG. 2C.

As shown in FIGS. 2A to 2C and 3A to 3C, the developing device 5′ is in a form of a long container. The developing device 5′ includes a toner container 25, a supply roller 26, a development roller 27, and a toner restraint member 28 in a long housing 24. The toner container 25, the supply roller 26, the development roller 27, and the toner restraint member 28 each extend in the longitudinal direction of the developing section 51. The supply roller 26 is disposed in the toner container 25. The toner container 25 has a toner supply path 29 and a toner supply hole 30 through which a new toner is supplied.

The supply roller 26 can be rotated clockwise as designated by arrow δ shown in FIGS. 3A and 3B. The supply roller 26 supplies the toner in the toner container 25 to the development roller 27.

The development roller 27 can be rotated counterclockwise as designated by arrow ε shown in FIGS. 3A and 3B. The development roller 27 conveys the toner supplied from the supply roller 26 to the photoreceptor 3 while the toner restraint member restraints the layer of the toner at a predetermined pressure at the developing point. Then, the electrostatic latent image on the photoreceptor 3 is developed with the toner conveyed by the development roller 27. Thus, toner images of respective colors are formed on the photoreceptor 3.

As shown in FIGS. 2C and 3A to 3C, recesses 31 and protrusions 32 are alternately formed in the longitudinal direction (lateral direction in FIG. 2C) of the developing device 5′ at the inner wall 24a of the housing 24 opposing the supply roller 26, opposite to the development roller 27. The recesses 31 and protrusions 32 are integral with the housing 24. The recess 31 is formed in such a manner that the width in the longitudinal direction of the developing device 5′ is gradually reduced upward. In addition, the walls of the recess defining the width are curved. The walls of the recess 31 defining the width may be straight or crimped. In the developing device 5′ of the embodiment, eight recesses 31 are formed.

The protrusions 32 include intermediate protrusions 32a formed on the inner side of their arrangement, and left and right protrusions 32b and 32c formed at the ends of the arrangement. The intermediate protrusion 32a is formed in such a manner that the width in the longitudinal direction is gradually increased upward, in the opposite manner from the shape of the recess 31. The walls of the intermediate protrusion 32a defining the width in the longitudinal direction are curved upward. The walls of the intermediate protrusion 32a defining the width may be straight or crimped. In the developing device 5′ of the embodiment, seven intermediate protrusions 32a are formed. The left protrusion 32b is formed in such a manner that the boundary with the recess 31 is slanted and the opposite side stands perpendicular to the longitudinal direction of the developing device 5′. The right protrusion 32c is symmetric to the left protrusion 32b with respect to a line perpendicular to the longitudinal direction.

The recess 31 has a vertical upper wall 31a distant from the supply roller 26 and a slanted lower wall 31b close to the supply roller 26, as shown in FIG. 3A. The vertical upper wall 31a and the slanted lower wall 31b are continuously formed with a rounded bend 31c therebetween. The lower wall 31b is slanted so as to get closer to the supply roller 26 downward. The slanted lower wall 31b thus opposes the supply roller 26.

The protrusion 32 has a vertical upper wall 32d distant from the supply roller 26 and a slanted lower wall 32e close to the supply roller 26, as shown in FIG. 3B. The vertical upper wall 32d and the slanted lower wall 32e are continuously formed with an edge 32f therebetween. The lower wall 32e is slanted so as to get closer to the supply roller 26 downward. Since the slanted lower walls 31b and 32e get closer to the supply roller 26 downward, the step height between the recess 31 and the protrusion 32 is gradually increased toward the opposite side to the supply roller 26. The slanted lower wall 32e of the protrusion thus opposes the supply roller 26. While FIG. 33 shows only the cross section of one of the intermediate protrusions 32a, the left and right protrusions 32b and 32c have the same cross section as the intermediate protrusions 32a.

The recesses 31 and the protrusions 32 shown in FIGS. 2C and 3C are formed such that their boundaries 33 diverge upward from the bottoms of the recesses 31 (toward the opening of the recesses), as shown in FIG. 3C. In this instance, the boundary 33b between the slanted lower walls 31b and 32e close to the supply roller 26 has a relatively large tilt angle (steeper), and the boundary 33a between the vertical upper walls 31a and 32d has a relatively small tilt angle (more gentle).

As shown in FIG. 2C, the recesses 31 and the protrusions 32 are arranged according to the sizes of transfer materials 8 such that the protrusions 32 are located substantially at the ends in the lateral direction of the transfer materials 8 in orientations in which the transfer materials 8 are transported (in FIG. 2C, the protrusions 32 are located at the positions corresponding to the ends in the lateral direction of an A5 sheet transported in portrait orientation or in landscape orientation or the ends in the lateral direction of an A4 sheet transported in portrait orientation).

In the developing device 5′ having the above-described structure, the toner is supplied to the development roller 27 by rotating the supply roller 26 in the δ direction. The toner supplied to the development roller 27 is conveyed to the photoreceptor 3 with restraint by the restraint member 28, and the residue of the toner, not conveyed to the photoreceptor 3, is removed from the development roller 27. The removed toner and the toner in the lower position of the toner container 25 are moved (conveyed) toward the inner wall 24a of the housing by the rotation of the supply roller 26.

The toner moved to the inner wall 24a is collected in the recesses 31 whose widths in the longitudinal direction of the developing device 5′ are increased downward, and flows upward in the ζ direction along the slanted lower walls 31b inside the recesses 31. The toner flowing in the recesses 31 moves upward, receiving a force from both sides in the longitudinal direction while the toner passage is reduced by the boundaries 33b. Since the boundaries 33b are slanted as described above and the toner receives a force in the longitudinal direction, part of the toner flowing upward is turned to the left and the right of the longitudinal direction and moves to the slanted lower walls 32e of the protrusions 32 via the boundaries 33b.

At this time, the toner flows to the slanted lower walls 32e of the intermediate protrusions 32a from the recesses 31 adjacent to the intermediate-protrusions 32a. The streams of the toner flowing to the slanted lower walls 32e of the intermediate protrusions 32a from both sides in the longitudinal direction merge together and flow downward. Also, the toner flows to the slanted lower wall 32e of the left protrusion 32b from the recess 31 immediately to the right of the left protrusion 32b. The toner over the slanted lower wall 32e of the left protrusion 32b flows downward along the left wall 24b of the housing 24. Also, the toner flows to the slanted lower wall 32e of the right protrusion 32c from the recess 31 immediately to the left of the right protrusion 32c. The toner over the slanted lower wall 32e of the right protrusion 32c flows downward along the right wall 24c of the housing 24. The toner passage at the slanted lower wall 32e is reduced in a relatively small degree, and the boundary 33b has a relatively large tilt angle. Accordingly, the flow rate of the toner is low. Thus, a relatively small amount of toner flows not far via the boundaries 33b in the longitudinal direction.

The other part of the toner flowing upward moves in the recesses 31 through the rounded bends 31c while the toner passage is reduced by the boundaries 33b, and thus reaches the vertical upper walls 31a. Since the bend 31c is rounded, the toner smoothly flows upward. The toner flowing upward along the vertical upper walls 31a in the recesses 31 receives a force in the longitudinal direction by the boundaries 33a as above. Consequently, the stream of the toner turns to the right and the left of the longitudinal direction, and reaches the vertical upper walls 32d of the protrusions 32 via the boundaries 33a.

At this time, the toner flows to the vertical upper walls 32d of the intermediate protrusions 32a from the recesses 31 adjacent to the intermediate protrusions 32a. The streams of the toner flowing to the vertical upper walls 32d of the intermediate protrusions 32a from both sides in the longitudinal direction merge together and flow downward. Also, the toner flows to the vertical upper wall 32d of the left protrusion 32b from the recess 31 immediately to the right of the left protrusion 32b. The toner over the vertical upper wall 32d of the left protrusion 32b flows downward along the left wall 24b of the housing 24. Also, the toner flows to the vertical upper wall 32d of the right protrusion 32c from the recess 31 immediately to the left of the right protrusion 32c. The toner over the vertical upper wall 32d of the right protrusion 32c flows downward along the right wall 24c of the housing 24.

In this instance, the toner passage at the vertical upper wall 31a is reduced in a relatively large degree and the boundary 33a has a relatively small tilt angle. Accordingly, the flow rate of the toner becomes high. Thus, a relatively large amount of toner flows far via the boundaries 33a in the longitudinal direction.

When a new toner is supplied to the toner container 25 through the toner supply hole 30, the new toner flows in the same manner as above together with the toner previously present in the toner container 25. Thus, the new toner and the previously present toner are mixed effectively.

In the developing device 5′ of the embodiment, recesses 31 and protrusions 32 are formed at the inner wall 24a of the housing 24 opposing the supply roller 26 so that the stream of the toner is turned to the right and left of the longitudinal direction. Consequently, the toner in the toner container 25 is allowed to flow upward by the rotation of the supply roller 26. The upper stream of the toner is turned to the right and left of the longitudinal direction by the boundaries 33 between the recesses 31 and the protrusions 32, and the streams of the toner flow downward along the left and right walls 24b and 24c of the housing 24. The toner is thus circulated in the vertical direction and to the right and left of the longitudinal direction by the rotation of the supply roller 26 and is thus agitated effectively without forcible agitation.

Thus, the degradation of the toner can be prevented. Even if the toner is degraded, the degraded toner does not lean to one side. Thus, fog or leakage of the toner from the toner restraint member 28 can be reduced.

In particular, the width of the recess 31 in the longitudinal direction of the developing device 5′ is increased toward the supply roller 26, and reduced toward the opposite side to the supply roller 26. In addition, the width of the protrusion 32 in the longitudinal direction of the developing device 5′ is reduced toward the supply roller 26 and increased toward the opposite side to the supply roller 26, and predetermined numbers of recesses 31 and protrusions 32 are alternately arranged in the longitudinal direction of the developing device. Consequently, the force in the longitudinal direction applied to the toner from the boundaries 33a and 33b is increased as the distance between the toner and the supply roller 26 is increased. Thus, the toner can efficiently be moved in the longitudinal direction by the rotation of the supply roller 26.

In addition, the step height between the recesses 31 and the protrusions 32 is increased toward the opposite side to the supply roller 26, and the boundaries 33a and 33b between the recesses 31 and the protrusions 32 have a tilt angle that is smaller at a side distant from the supply roller 26 than at a side closer to the supply roller 26. Thus, the toner can more efficiently be moved in the longitudinal direction of the developing device by the rotation of the supply roller 26. Thus, the toner can be sufficiently agitated.

In the developing device 5′ of the embodiment, the toner is moved and agitated only by the rotation of the supply roller 26. The structure of the embodiment can be applied to any developing device other than the rotary developing device, including a tandem developing type and a monochrome developing type, as long as a supply roller 26 is used.

Furthermore, the recesses 31 and the protrusions 32 are integral with the housing 24 of the developing device 5′. Accordingly, the internal structure of the toner container 25 can be simple and the toner container 25 can be small. Accordingly, the developing device 5′ can be simple and small.

The protrusions 32 are arranged according to the sizes of transfer materials 8 so as to be located substantially at the ends in the lateral direction of the transfer materials 8 in orientations in which the transfer materials 8 are transported. Thus, the difference in degree of degradation of the toner caused by circulating the toner particularly when a small transfer material 8 is printed can be reduced between the printing region and the region outside the printing region.

Also, the recesses 31 and the protrusions 32 are arranged in the longitudinal direction at a pitch that is recued toward the center of the arrangement and increased toward the ends of the arrangement. Consequently, the toner can be agitated finely at the center in the longitudinal direction of the developing device and roughly at the ends of the developing device.

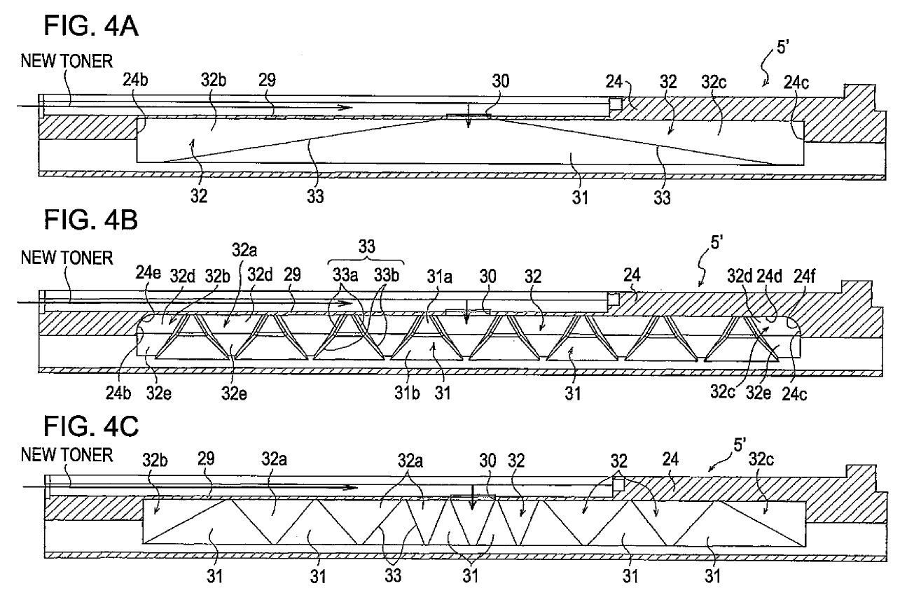

FIGS. 4A to 4C are sectional views similar to FIG. 2C showing developing devices according to other embodiments of the invention.

In the developing device 5′ shown in FIG. 4A, the inner wall 24a of the housing has a single recess 31 and protrusions 32b and 32c adjacent to both sides of the recess 31 in the longitudinal direction of the developing device 5′. In this embodiment, the toner in the toner container 25 is roughly moved to the right and left of the longitudinal direction of the developing device 5′ by the rotation of the supply roller 26. In FIG. 4A, the vertical upper walls 31a and 32d and the slanted lower walls 31b and 32e are omitted.

In the developing device 5′ shown in FIG. 4B, the corners 24e and 24f between the left and right walls 24b and 24c and the upper wall 24d of the housing are rounded. Consequently, the toner flowing to the vertical upper walls 32d of the left and right protrusions 32b and 32c can be smoothly turned downward along the rounded corners 24e and 24f. Thus, the toner can be prevented from being compacted.

In the developing device 5′ shown in FIG. 4C, the recesses 31 and the protrusions 32 are arranged in the longitudinal direction at a pitch that is reduced toward the center of the arrangement and increased toward the ends of the arrangement. Hence, the widths of the recesses 31 and the protrusions 32 in the longitudinal direction of the developing device 5′ are reduced toward the center of the arrangement and increased toward the ends of the arrangement. Consequently, the toner is agitated finely at the center in the longitudinal direction of the developing device and roughly at the ends of the developing device.

These developing devices 51 shown in FIGS. 4 A to 4C can be used in the image-forming apparatus shown in FIG. 1 including a rotary developing unit 5.

However, the developing devices of the above embodiments may be used in other image-forming apparatuses without limitation. The embodiments may be applied to various image-forming apparatuses using a toner supply roller, including an image-forming apparatus in which developing devices are arranged in a tandem manner, a four-cycle image-forming apparatus, and a monochrome image-forming apparatus. The invention can be applied to any image-forming apparatus without departing from the scope of the invention.

The entire disclosure of Japanese Patent Application No. 2008-017201, filed Jan. 29, 2008 is expressly incorporated by reference herein.

What is claimed is:

1. A developing device comprising:
a housing having inner walls;
a toner container disposed in the housing;
a supply roller disposed in the toner container so as to oppose one of the inner walls, the supply roller rotating to move a toner; and
a development roller to which the toner is supplied from the supply roller,
wherein the inner wall of the housing opposing the supply roller has a recess and a protrusion that allow the toner moved by the rotation of the supply roller to flow in a specific direction so as to agitate the toner.

2. The developing device according to claim 1, wherein the recess has a width in the specific direction and the width of the recess is increased toward the supply roller and reduced toward the opposite side to the supply roller.

3. The developing device according to claim 2, wherein the protrusion has a width in the specific direction and the width of the protrusion is reduced toward the supply roller and increased toward the opposite side to the supply roller, and predetermined numbers of the recesses and the protrusions are alternately arranged in the specific direction.

4. The developing device according to claim 3, wherein two protrusions of the alternately arranged recesses and protrusions are located at both ends of the arrangement of the recesses and the protrusions.

5. The developing device according to claim 3, wherein the recesses and the protrusions have a step height therebetween increasing toward the opposite side to the supply roller.

6. The developing device according to claim 3, wherein the boundaries between the recesses and the protrusions have slopes diverging from the bottoms of the recesses toward the opening of the recesses.

7. The developing device according to claim 6, wherein the slopes of the boundaries have a tilt angle that is smaller on a side distant from the supply roller than on a side closer to the supply roller.

8. The developing device according to claim 3, wherein the protrusions are arranged in such a manner that at least two of the protrusions are located at both ends of a transfer material in the lateral direction in an orientation in which the transfer material is transported.

9. The developing device according to claim 3, wherein the recesses and the protrusions are alternately arranged at a pitch that is reduced toward the center of the arrangement and increased toward the ends of the arrangement.

10. An image-forming apparatus comprising:
a latent image support; and
the developing device as set forth in claim 1, the developing device developing an electrostatic latent image on the latent image support with a toner.
